(19) United States
(12) Patent Application Publication
(10) Pub. No.: US 2023/0264529 A1
(43) Pub. Date: Aug. 24, 2023

(54) Noise Isolator for Quiet Ball Mount

(71) Applicant: U-Haul International, Inc., Phoenix, AZ (US)

(72) Inventor: Marco Garcia, Chandler, AZ (US)

(21) Appl. No.: 17/651,938

(22) Filed: Feb. 22, 2022

(51) Int. Cl. B60D 1/24; B60D 1/06; B60D 1/145

(52) U.S. Cl. CPC B60D 1/241; B60D 1/065; B60D 1/145

(57) ABSTRACT

An improved hitch ball mount includes a draw bar shank having vibration-isolating member disposed over a portion of an outer surface of a draw bar rod. The vibration-isolating member comprises a vibration-absorbing material, and the draw bar shank is sized to fit closely within a receiver tube of a receiver hitch assembly so that the vibration-isolating member contacts the interior of the receiver tube when the draw bar is positioned within the receiver tube. The vibration-absorbing material can comprise a layer of composite or rubberized material. The vibration-isolating member can be a removable sleeve that can be slidingly positioned over the draw bar rod or it can be a layer of vibration-absorbing material molded over a portion of the draw bar rod. In some embodiments, one or more protrusions can be disposed on the outer surface of the draw bar rod.

### BACKGROUND

This invention relates generally to receiver hitch assemblies for coupling a towing vehicle to a trailer or other object to be towed. More specifically, the invention relates to a hitch ball mount (also known as a draw bar) of a receiver hitch assembly that includes a vibration-isolating member that reduces noise transmitted from the hitch to the towing vehicle.

Typically, the receiver of a receiver hitch assembly will include a metal receiver tube, and the ball mount (or draw bar) will include a draw bar shank that fits into the receiver tube. In order for the draw bar shank to be easily inserted into the receiver tube, the receiver tube will be slightly larger than the draw bar shank. Due to this slight difference in size, the draw bar shank will have a tendency to move within the receiver tube and thereby produce a rattling noise. While the movement and resultant noise may not have a detrimental effect on the receiver hitch assembly, the rattling noise tends to be an annoyance.

Prior art apparatus intended to address this noise issue suffer from a number of disadvantages. For example, they have numerous components and as a result are complex to install and have correspondingly high manufacturing and maintenance costs. Therefore, there is a continuing need for an improved apparatus that reduces rattling in a receiver hitch assembly. It is an object of the present invention to provide such an apparatus.

It is another object of the present invention to provide such an apparatus that is relatively inexpensive to manufacture and is easy to use.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided an improved hitch ball mount that includes a draw bar shank and an opposing ball support portion. The draw bar shank has a draw bar rod and a vibration-isolating member disposed on a portion of an outer surface of the draw bar rod. The vibration-isolating member comprises a vibration-absorbing material. The draw bar shank is sized to fit closely within a receiver tube of a receiver hitch assembly so that, when the draw bar shank is positioned within the receiver tube, the vibration-isolating member contacts the interior of the receiver tube and holds the draw bar rod in a spaced relationship with the interior of the receiver tube. In some embodiments, one or more protrusions can be disposed on the outer surface of the draw bar rod. The vibration-absorbing material can include a layer of composite or rubberized material. The vibration-isolating member can include side holes sized for receiving a hitch pin. In some embodiments, the vibration-isolating member can be removable from the draw bar rod. For example, the vibration-isolating member can include a sleeve configured to be slidingly positioned over the draw bar rod. In some embodiments, the vibration isolating member can include a sleeve of vibration-absorbing material molded over a portion of the draw bar rod.

Also in accordance with the present invention, a vibration-isolating member for use with a hitch ball mount includes a sleeve comprising a vibration-absorbing material. The sleeve is configured to fit closely over a portion of the outer surface of a draw bar rod of a hitch ball mount and to fit closely within a receiver tube of a receiver hitch assembly. When the draw bar is positioned within the receiver tube, the vibration-isolating member contacts the interior of the receiver tube and isolates the draw bar rod from contact with the interior of the receiver tube. The sleeve can include a side hole in each of two opposing side walls and the side holes can be sized to receive a hitch pin. In some embodiments, the sleeve is removable from the draw bar rod. In other embodiments, the sleeve can comprise a layer of vibration-absorbing material molded over the draw bar rod.

In the foregoing embodiments, the invention reduces the movement—and the resulting rattling noise—that occurs between a receiver and ball mount of a receiver hitch assembly and thereby reduces the transmission of noise into the towing vehicle cabin, whether such movement is generated by a trailer or by the draw bar without a trailer.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 is a perspective view of one embodiment of a hitch ball mount with a draw bar shank that includes a removable vibration-isolating member according to the present invention.

FIG. 2 is a perspective view of one embodiment of the removable vibration-isolating member of the draw bar shank according to the present invention.

FIG. 3 is a perspective view of a receiver hitch assembly showing the hitch ball mount of FIG. 1 with the draw bar shank inserted into a receiver mounted to a towing vehicle.

FIG. 4 is a side elevation partial cross-sectional view of a receiver hitch assembly utilizing a hitch ball mount that includes a draw bar shank according to the present invention, wherein the draw bar shank is shown in engagement with the upper and lower interior surfaces of the receiver tube.

FIG. 5 is a top perspective view of a receiver hitch assembly utilizing the hitch ball mount of FIG. 1 with the draw bar shank of the hitch ball mount inserted into a receiver mounted to a towing vehicle.

FIG. 6 is an enlarged bottom perspective view of a portion of another receiver hitch assembly utilizing the hitch ball mount of FIG. 1 with the draw bar shank of the hitch ball mount inserted into a receiver mounted to a towing vehicle.

FIG. 7 is a rear elevation cross-sectional view of the receiver of the receiver hitch assembly shown in FIG. 4 and taken through line A-A of that figure.

FIG. 8 is a side elevation partial cross-sectional view of a receiver hitch assembly utilizing another embodiment of a hitch ball mount according to the present invention, wherein the draw bar shank of the hitch ball mount has a vibration-isolation member that is molded over the draw bar rod.

### DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

It will be appreciated that terms such as “front,” “forward,” “rear,” “rearward,” “upper,” “inner,” “outer,” “vertical,” “horizontal,” “bottom,” “below,” “top,” “side,” “inwardly,” “outwardly,” “downwardly” and “lower” and other positionally descriptive terms used in this specification are used merely for ease of description and refer to the orientation of the referenced components as shown in the figures. It should be understood that any orientation of the components described herein is within the scope of the present invention.

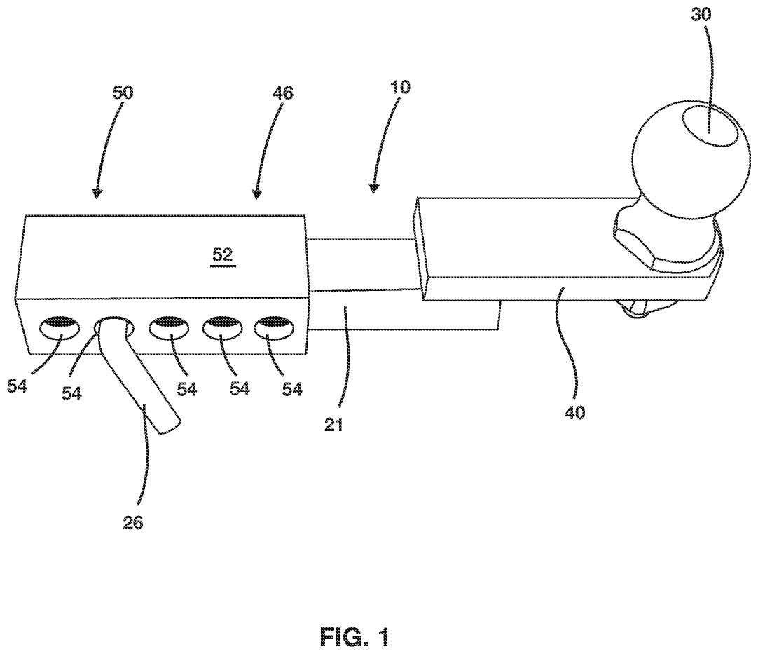

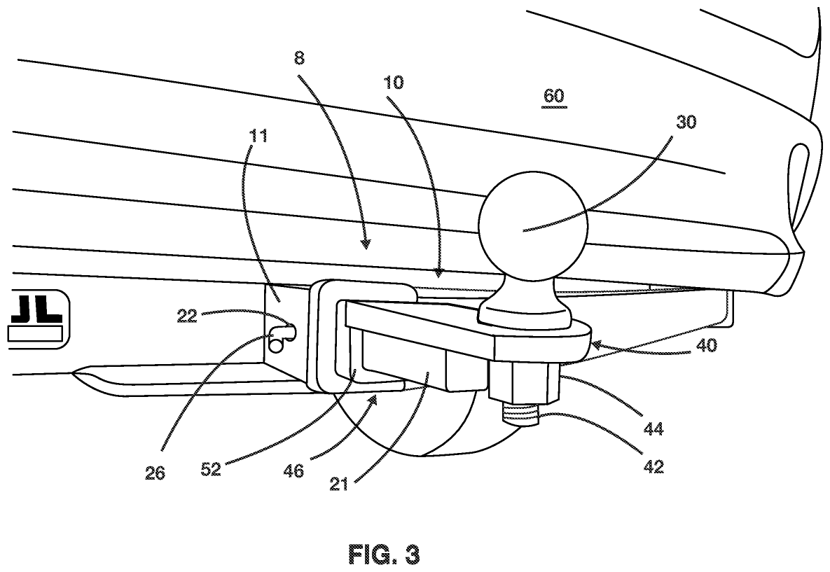

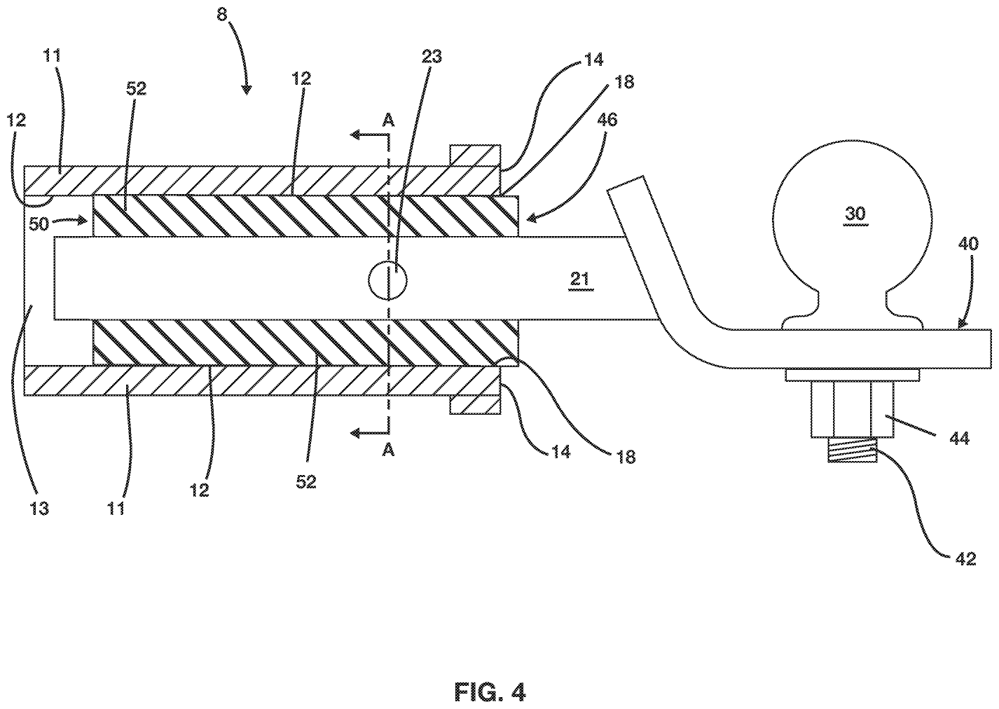

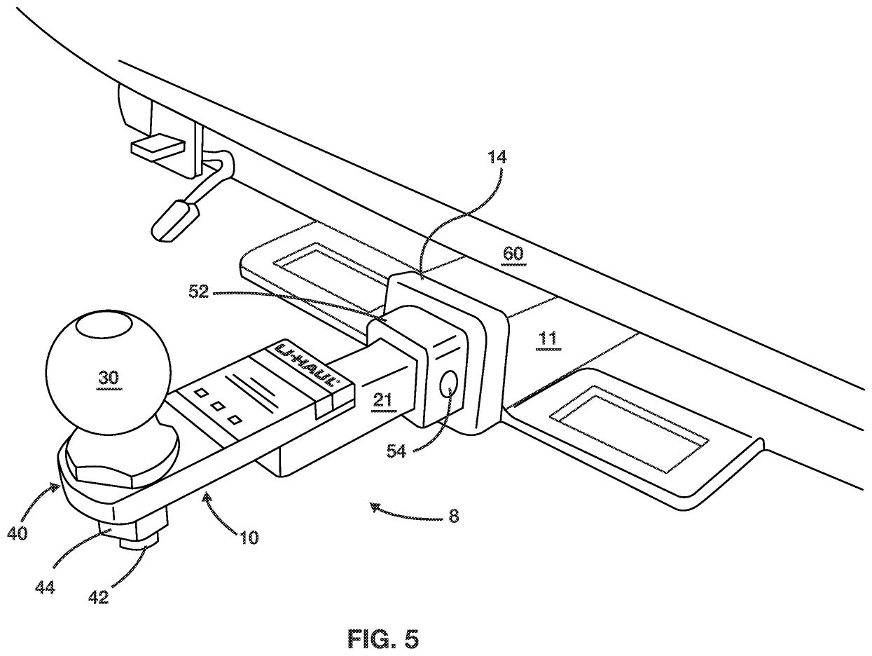

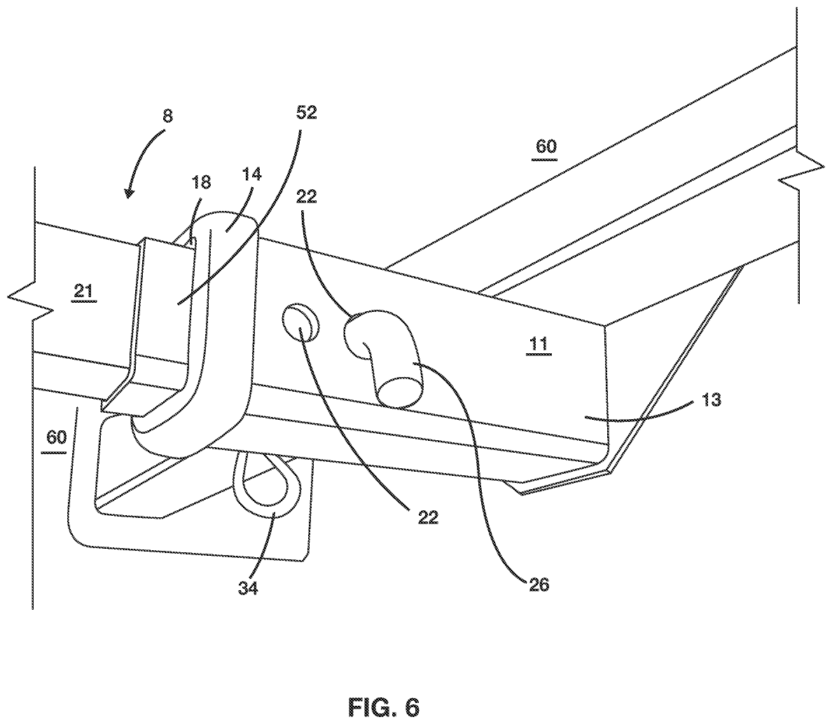

FIGS. 1 and 3-4 illustrate one embodiment of a hitch ball mount, generally designated as 10 according to the present invention. The hitch ball mount 10 is designed for use as part of a receiver hitch assembly 8 that also includes a receiver 11 to be mounted to a towing vehicle 60 as described in more detail below (see FIGS. 3-6). The hitch ball mount 10 includes a draw bar shank 46 and an opposing ball mount portion 40 that supports a hitch ball 30. The draw bar shank 46 includes a draw bar rod 21 and a vibration-isolating member 50 that closely fits over the outer surface of the draw bar rod 21. The hitch ball 30 has a threaded shank 42 and is removably mounted to the ball mount portion 40 with a hitch ball nut 44 (see FIG. 4). Each of the opposing sides of the receiver 11 includes one or more side holes 22 sized for receiving a hitch pin 26. The draw bar rod 21 includes one or more lateral holes 23, which also are sized for receiving the hitch pin 26 and which can be aligned with a set of the opposing side holes 22 in the receiver 11 as described below.

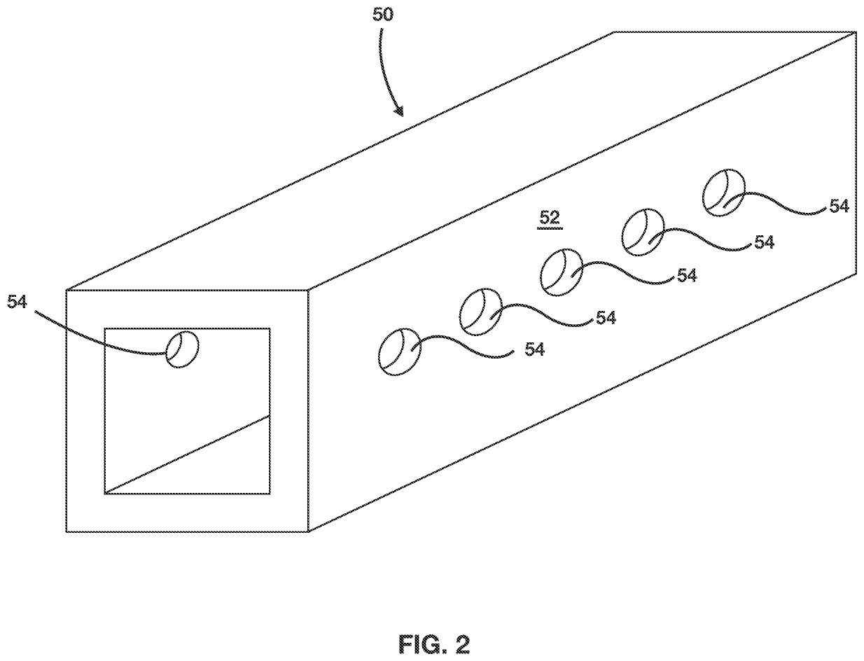

Referring to FIGS. 1-4, the vibration-isolating member 50 comprises a sleeve 52 that is made of vibration-absorbing material. In some embodiments, the sleeve 52 is removable from the draw bar rod 21. Each of the opposing sides of the sleeve 52 includes one or more sets of opposing side holes 54 sized for receiving the hitch pin 26. The sleeve 52 is sized and shaped to fit closely over the draw bar rod 21 of the hitch ball mount 10 with a set of the opposing sleeve side holes 54 aligned with a set of the opposing receiver side holes 22. Also, the sleeve 52 is sized and shaped to fit closely within the receiver tube 12 (as described below) so that, when the draw bar shank 46 of the hitch ball mount 10 is positioned within the receiver tube 12, the sleeve 52 contacts the interior of the receiver tube 12 and holds the draw bar rod 21 in a spaced relationship with the interior of the receiver tube 12 to help isolate the draw bar rod 21 from moving into contact with the interior of the receiver tube 12 (see FIGS. 3-4). For example, in some embodiments, the sleeve 52 is sized to fit closely over a 1¼ inch draw bar and also to fit closely within a 2 inch receiver. Also, as can be seen in FIG. 4, in some embodiments the sleeve 52 has generally planar exterior surfaces that contact the interior surfaces of the receiver tube 12. Upon reading this specification, however, it will be understood that one or more of the exterior surfaces of the sleeve 52 can be a course surface or can have an outwardly projecting surface feature, such as bumps, ridges, or other projections, configured to contact a portion of the interior of the receiver tube 12 so as to reduce contact between the draw bar rod 21 and the interior of the receiver tube 12.

In some embodiments, the vibration-absorbing material of the sleeve 52 comprises polyurethane, nylon, natural or synthetic rubber, plastic, or composite materials having vibration-absorbing characteristics. In one presently preferred embodiment, the sleeve 52 comprises a vibration-absorbing material (e.g., polyurethane) having a hardness of 60 or higher on the Shore 00 scale or a hardness of 20 or higher on the Shore A scale.

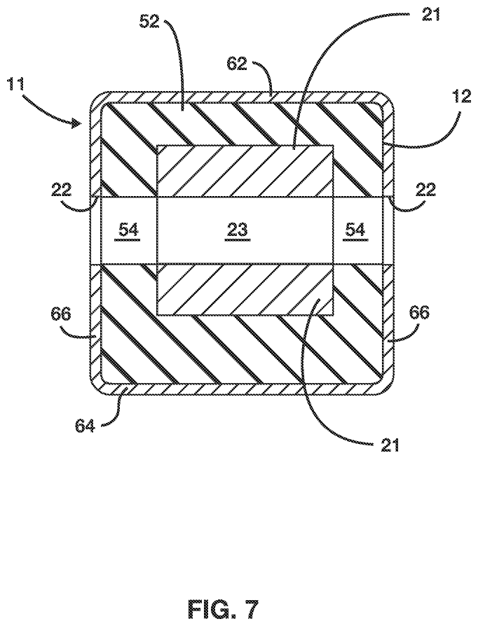

As can be seen in FIGS. 3-7, a hitch ball mount 10 according to the present invention is used with a receiver hitch assembly 8 by inserting the draw bar shank 46 (including the vibration-isolating member 50) into a receiver 11 mounted to a towing vehicle 60. The receiver 11 includes a receiver tube 12 that has a forward end 13 and free rearward end 14 with an opening 18 for receiving the draw bar shank 46. The receiver tube 12 also has a top wall 62, a bottom wall 64 and two opposing side walls 66 (see FIG. 7). Each of the receiver side walls 66 has a receiver side hole 22 for receiving the lateral hitch pin 26. As previously discussed, the draw bar shank 46 includes the sleeve 52, which has a pair of opposing sleeve side holes 54 aligned with the lateral hole 23 of the draw bar rod 21. In this configuration, when the draw bar shank 46 is inserted into the receiver tube 12 so that the lateral hole 23 of the draw bar rod 21 and the sleeve side holes 54 are aligned with the receiver side holes 22, the hitch pin 26 can be inserted through the aligned holes 22, 54, 23 to prevent the draw bar shank 46 from moving longitudinally within the receiver tube 12. The hitch pin 26 can be held in place by a hitch pin clip 34, as is known in the art, to prevent lateral forces from removing the hitch pin 26 from the holes 22, 54, 23.

Still referring to FIGS. 3-7, when the draw bar shank 46 is disposed in the receiver tube 12 with the hitch pin 26 inserted, longitudinal movement of the draw bar shank 46 within the receiver tube 12 is restricted during towing. In addition, as described above, the sleeve 52 contacts the interior of the receiver tube 12 and isolates the draw bar rod 21 from moving into contact with the interior of the receiver tube 12, thereby reducing the rattling noise associated with such contact. A user of the hitch ball mount 10 can simply and conveniently remove it from the receiver tube 12 by removing the hitch pin clip 34 and the hitch pin 26, then pulling the hitch ball mount 10 in a rearward direction to slide the draw bar shank 46 out of the receiver tube 12.

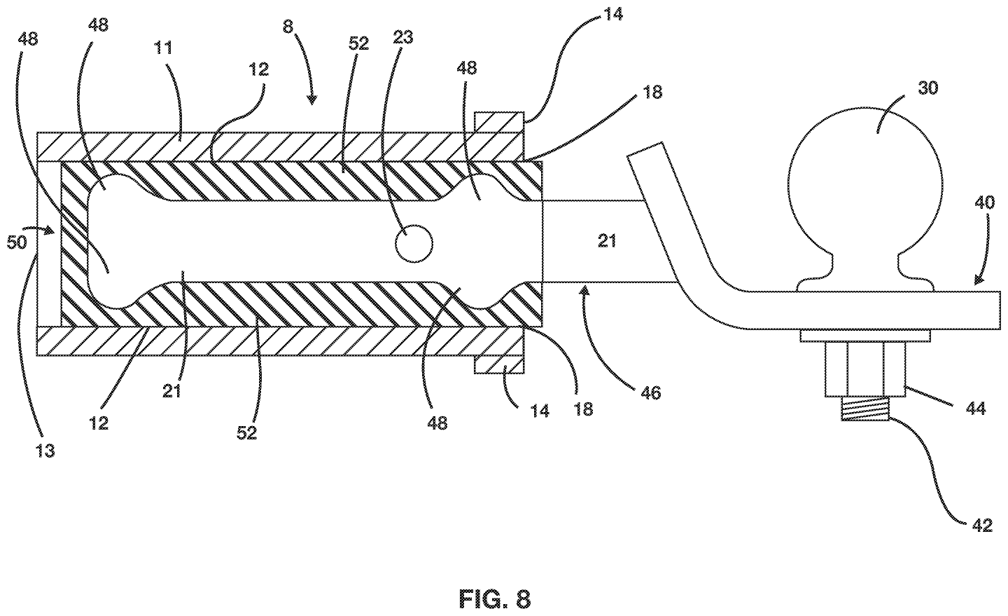

FIG. 8 illustrates a receiver hitch assembly 8 that utilizes another embodiment of a hitch ball mount 10 according to the present invention. In this embodiment, the draw bar shank 46 of the hitch ball mount 10 has a vibration-isolating member 50 that is molded over the draw bar rod 21 to form the sleeve 52. In some embodiments, the draw bar rod 21 has raised protrusions 48 disposed on the circumference of the draw bar rod 21. The draw bar rod 21 can have (but need not necessarily have) a square transverse cross-section. The protrusions 48 help to restrict lateral movement between the draw bar shank 46 and the receiver tube 12 during towing due to tongue weight of the towed trailer. The protrusions 48 can be formed by rings or ribs on the circumference of the draw bar rod 21, which also help to stiffen the draw bar rod 21. The sleeve 52 can be made of a solid vibration-absorbing material that is molded over the draw bar rod 21 such that the draw bar shank 46 has a square cross section to fit closely within the receiver tube 12. In such an embodiment, the draw bar shank 46 will have the external appearance of a uniform square sleeve of a vibration-absorbing material molded over the metal draw bar rod 21.

Still referring to FIG. 8, in some embodiments the draw bar rod 21 is made of metal and can be fabricated using a standard size shank having a square cross-section. The protrusions 48 can be formed by welding rings onto the draw bar rod 21. In this configuration, a smaller shank can be used, which can reduce the cost of manufacture. The vibration-isolating member 50 can be formed as a sleeve 52 molded over the draw bar rod 21 by placing the draw bar rod 21 into a composite mold. A vibration-absorbing composite material can then be pumped through or poured into the mold and allowed to cool or cure sufficiently to remove the components of the draw bar shank 46 as a solid assembly. Some suitable vibration-absorbing materials for forming such an over-molded sleeve can include ABS injection molded plastic, injection molded silicon rubber, and injection molded polyurethane. Preferably, such vibration-absorbing material would have a hardness of 60 or higher on the Shore 00 scale or 20 or higher on the Shore A scale.

From the foregoing, it can be seen that the apparatus of the present invention possesses numerous advantages. It provides an assembly of relative simple and economical construction that can be used with a standard receiver without modifying the receiver tube and is cost-effective to manufacture and maintain, and yet it still can effectively eliminate rattling during towing.

Upon reading this disclosure, additional advantages and modifications will readily occur to those skilled in the art. Therefore, the invention in its broader aspects is not limited to the specific details, representative devices, and illustrative examples shown and described. Accordingly, departures may be made from such details without departing from the spirit or scope of the general inventive concept.

What is claimed is:

1. A hitch ball mount comprising:
a draw bar shank and an opposing ball support portion;
wherein the draw bar shank comprises a draw bar rod and a vibration-isolating member disposed on an outer surface of the draw bar rod; and
wherein the draw bar shank is sized to fit closely within a receiver tube of a receiver hitch assembly so that, when the draw bar shank is positioned within the receiver tube, the vibration-isolating member contacts a portion of the interior of the receiver tube and holds the draw bar rod in a spaced relationship with the interior of the receiver tube.

2. The hitch ball mount of claim 1 wherein the vibration-isolating member includes a side hole sized for receiving a hitch pin.

3. The hitch ball mount of claim 1 wherein the vibration-isolating member comprises a vibration-absorbing material.

4. The hitch ball mount of claim 3 wherein the vibration-absorbing material comprises a composite or rubberized material.

5. The hitch ball mount of claim 1 wherein the vibration-isolating member comprises layer of vibration-absorbing material molded over the draw bar rod.

6. The hitch ball mount of claim 1 wherein the vibration-isolating member includes a side hole in each of two opposing side walls and each of the side holes is sized to receive a hitch pin.

7. The hitch ball mount of claim 1 wherein the vibration-isolating member is removable from the draw bar rod.

8. The hitch ball mount of claim 7 wherein the vibration-isolating member comprises a sleeve configured to be slidingly positioned over the draw bar rod.

9. The hitch ball mount of claim 1 further comprising one or more protrusions disposed on an outer surface of the draw bar rod.

10. A vibration-isolating member for use with a hitch ball mount, the vibration-isolating member comprising:
a sleeve comprising a vibration-absorbing material, wherein the sleeve is configured (i) to fit closely over a draw bar rod of a hitch ball mount, (ii) to fit closely within an interior of a receiver tube of a receiver hitch assembly, and (iii) to hold the draw bar rod in a spaced relationship with a surface of the interior of the receiver tube when the draw bar rod is positioned within the interior of the receiver tube with the sleeve disposed over the draw bar rod and in contact with the interior surface of the receiver tube.

11. The vibration-isolating member of claim 10 wherein the vibration-absorbing material comprises a composite or rubberized material.

12. The vibration-isolating member of claim 10 wherein the sleeve includes a side hole in each of two opposing sleeve side walls and each of the side holes is sized to receive a hitch pin.

13. The vibration-isolating member of claim 10 wherein the sleeve is removable from the draw bar rod.

14. A receiver hitch assembly comprising in combination:
a hitch ball mount including a draw bar shank and an opposing hitch ball support portion; and
a receiver tube having a rearward end, and a top wall, a bottom wall and two opposing side walls defining a receiver tube interior surface, wherein the receiver tube rearward end includes an opening sized for receiving the hitch ball mount draw bar shank;
wherein the draw bar shank includes a draw bar rod and a vibration-isolating member comprising a vibration-absorbing material disposed about a circumference of the draw bar rod;
wherein the draw bar shank is sized to fit closely within the receiver tube so that, when the draw bar shank is positioned within the receiver tube, the vibration-reducing member contacts a portion of the receiver tube interior surface and isolates the draw bar rod from contact with the receiver tube interior surface; and
wherein each of the opposing side walls of the receiver tube includes a side hole sized for receiving a hitch pin and the draw bar shank includes a lateral hole which can be aligned with the receiver side holes and which is sized for receiving the hitch pin.

15. The receiver hitch assembly of claim 14 wherein the vibration-isolating member comprises a composite or rubberized material.

16. The receiver hitch assembly of claim 14 wherein the vibration-isolating member comprises a sleeve configured to be slidingly positioned over the draw bar rod.

17. The receiver hitch assembly of claim 14 wherein the vibration-isolating member is removable from the draw bar rod.

18. The receiver hitch assembly of claim 14 wherein the vibration-isolating member comprises a layer of vibration-absorbing material molded over the draw bar rod.

19. The receiver hitch assembly of claim 14 wherein the vibration-isolating member comprises a side hole in each of two opposing side walls of the vibration-isolating member and each of the side holes is sized to receive a hitch pin.

20. The receiver hitch assembly of claim 14 wherein the draw bar rod comprises one or more protrusions disposed on a periphery of the draw bar shank.
